(19) United States
(12) Patent Application Publication
(10) Pub. No.: US 2025/0312822 A1
(43) Pub. Date: Oct. 9, 2025

(54) Dual Coil Mass Positioning System with Variable Oscillation Frequency

(71) Applicant: Google LLC, Mountain View, CA (US)

(72) Inventors: Khalid Lief Sorensen, College Place, WA (US); Kelly Elizabeth Dobson, Mountain View, CA (US); Nina R. Sinatra, Menlo Park, CA (US); Kurtis Robert Gross, Berkeley, CA (US); Franziska Schlagenhauf, Ludwigsburg (DE)

(21) Appl. No.: 18/855,256

(22) PCT Filed: Apr. 8, 2022
(86) PCT No.: PCT/US2022/023998

§ 371 Date: Oct. 8, 2024

(51) Int. Cl. B06B 1/02; B06B 1/04; H01F 7/06

(52) U.S. Cl. CPC B06B 1/0238; B06B 1/045; H01F 7/064; B06B 2201/70

(57) ABSTRACT

A mass positioning system includes a first end portion separated from a second end portion, a mechanical spring coupled to the first end portion, control circuitry configured to generate a first control signal and a second control signal, a first conductive coil proximate to the first end portion and configured to generate a first magnetic field in response to the first control signal, a second conductive coil proximate to the second end portion and configured to generate a second magnetic field in response to the second control signal, and a magnetic mass coupled to the mechanical spring and having a displacement that is responsive to the first magnetic field and the second magnetic field. The mass positioning system has an oscillation frequency that is controllable by the first control signal or the second control signal.

### FIELD

The present disclosure relates generally to a mass positioning system.

### BACKGROUND

Mass positioning systems are used in a variety of products to control the movement of a mass. For example, haptic actuators may generate a haptic output such as a vibration, click, and the like that is perceptible as a touch, pressure, or other feeling by a user of the product. Such haptic output can serve to alert users about the state of the products or otherwise convey information to the users. Mass positioning systems may also be used in other applications such as in automobiles as part of a suspension system. However, many products implementing haptic output lack the ability to finely control the haptic output due to inherent limitations in the design of the mass positioning system and associated controller.

### SUMMARY

Aspects and advantages of embodiments of the present disclosure will be set forth in part in the following description, or may be learned from the description, or may be learned through practice of the embodiments.

One example aspect of the present disclosure is directed to a mass positioning system including a first end portion separated from a second end portion, a mechanical spring coupled to the first end portion, control circuitry configured to generate a first control signal and a second control signal, a first conductive coil proximate to the first end portion and configured to generate a first magnetic field in response to the first control signal, a second conductive coil proximate to the second end portion and configured to generate a second magnetic field in response to the second control signal, and a magnetic mass coupled to the mechanical spring and having a displacement that is responsive to the first magnetic field and the second magnetic field. The mass positioning system has an oscillation frequency that is controllable by the first control signal or the second control signal.

Another example aspect of the present disclosure is directed to a method for positioning a magnetic mass in a mass positioning system. The method includes determining a first control signal for a first conductive coil and a second control signal for a second conductive coil of the mass positioning system. The determination of the first control signal and second control signal is based on a target displacement of the magnetic mass and a target oscillation frequency of the mass positioning system. The first conductive coil is proximate to a first end portion of the mass positioning system and is configured to generate a first magnetic field in response to the first control signal. The second conductive coil is proximate to the second end portion and is configured to generate a second magnetic field in response to the second control signal. The method includes providing the first control signal to the first conductive coil and the second control signal to the second conductive coil.

Yet another example aspect of the present disclosure is directed to a linear resonant actuator including a first end portion and a second end portion. The linear resonant actuator includes a mechanical spring coupled to the first end portion, a first conductive coil proximate to the first end portion and configured to generate a first magnetic field in response to a first control signal, a second conductive coil proximate to the second end portion and configured to generate a second magnetic field in response to a second control signal, and a magnetic mass coupled to the mechanical spring and having a displacement that is responsive to the first magnetic field and the second magnetic field.

Yet another example aspect of the present disclosure is directed to a method that includes applying a first control signal to a first conductive coil proximate a first end portion of a mass positioning system, applying a second control signal to a second conductive coil proximate to a second end portion of the mass positioning system, generating a first magnetic field by the first conductive coil in response to the first control signal, generating a second magnetic field by the second conductive coil in response to the second control signal, and displacing a magnetic mass to a target displacement at a target oscillation frequency affected by the first control signal and the second control signal.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 is a front perspective view of a mass positioning system in accordance with an example embodiment of the present disclosure;

FIG. 2A is a front perspective view of a mass displacement system in accordance with another example embodiment of the present disclosure;

FIG. 2B is an isometric cross-sectional view of a mass positioning system in accordance with an example embodiment of the present disclosure;

FIG. 3A is a partial circuit diagram depicting control signals and electromagnetic properties of a mass positioning system in accordance with an example embodiment of the present disclosure;

FIG. 3B is a block diagram depicting the inputs and outputs of a control scheme in accordance with an example embodiment of the present disclosure;

FIG. 4A depicts a flow chart illustrating a method for generating control signals to control a mass positioning system in accordance with an example embodiment of the present disclosure;

FIG. 4B depicts a flow chart illustrating a method for generating magnetic fields using conduction coils to control a magnetic mass in a mass positioning system in accordance with an example embodiment of the present disclosure;

FIG. 5 is a set of graphs illustrating displacement of a magnetic mass in accordance with an example embodiment of the present disclosure;

FIG. 6 is a set of graphs illustrating displacement of a magnetic mass in accordance with another example embodiment of the present disclosure; and

FIG. 7 illustrates an example user computing device in accordance with example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to mass positioning systems and methods for controlling a mass in a mass positioning system. Examples of mass positioning systems can include haptic output systems, such as linear resonant actuators in user devices, driving response systems such as suspensions in vehicles, vibration dampening systems, and the like. A mass positioning system in accordance with example embodiments includes multiple conductive coils that enable precise and accurate control of both the displacement and the oscillation frequency of the magnetic mass of the system. For example, coaxial conductive coils can be positioned at opposite end portions of a housing with a spring-mass-damper system positioned between the end portions. The motion of a magnetic mass of the spring-mass-damper system may be constrained to be coaxial with the pair of coaxial coils. The pair of conductive coils can be energized with independent control signals to provide an electromagnetic field gradient for precise control of the magnetic mass response. More particularly, the oscillation frequency of the mass positioning system can be altered by controlling the electromagnetic field gradient provided by the pair of coils.

According to an example aspect of the present disclosure, a mass positioning system such as a linear resonant actuator can include a lower and upper conductive coil positioned at opposite ends within a housing. A coaxial displacement of a magnetic mass between the opposite ends can be controlled by the electromagnetic field gradient provided by the pair of coils. The pair of conductive coils can be energized by independent control voltages to generate the electromagnetic field gradient. The resulting electromagnetic field gradient controls the oscillation frequency and the displacement of the magnetic mass within the housing. By providing a pair of independently energizable coaxial coils, the system has sufficient degrees of freedom to independently control both the displacement of the magnetic mass and the oscillation frequency of the mass positioning system. This enables the mass to be positioned arbitrarily within the housing while exhibiting a specified oscillatory frequency when perturbed.

In accordance with example embodiments, the electric polarity of the control voltages can be such that positive voltages applied to a given coil creates a magnetic polarity where N is in an upward direction relative to the housing and S is in a downward direction relative to the housing. By contrast, the magnetic mass can be oriented in such a way that the polarity is opposite that of the pair of coils. The magnetic mass may have N polarity in the downward direction and S polarity in the upward direction. In this manner, when either control voltage is positive, a repulsive force is generated between the mass and respective coil. Likewise, when either voltage is negative, an attractive force is generated between the mass and respective coil. By changing the voltage and/or polarity of the control voltages, the mass positioning system can enable precise control of both the displacement of the mass within the housing and the oscillation frequency of the mass when perturbed about a displacement point of equilibrium.

According to some example aspects, the mass positioning system can include a haptic output system such as a haptic actuator including a magnetic mass and two or more conductive coils that generate magnetic fields and a combined electromagnetic field gradient. The magnetic mass has a displacement and will exhibit a vibratory oscillation frequency when perturbed. The displacement and oscillation frequency is affected by the electromagnetic field gradient. The displacement of the mass and oscillation of the system mass provides a haptic output from the mass positioning system. Characteristics of the haptic output, such as duration and intensity, are affected by the displacement of the magnetic mass and the oscillation frequency at which the system oscillates.

For example, according to an aspect of the present disclosure, a mass positioning system can include a magnetic mass contained within a housing and two conductive coils positioned at opposite ends of the housing. The magnetic mass is connectively coupled by a spring to one end of the housing. The pair of conductive coils are coaxial with the motion of the mass constrained to be coaxial with the pair of coaxial coils. When control signals, such as control voltages, are applied to the conductive coils at either end of the housing, the conductive coils generate magnetic fields. The magnetic mass reacts to the magnetic fields and is displaced within the housing toward an equilibrium position away from a neutral or resting position. The magnetic mass also vibrates at an oscillation frequency when perturbed from the equilibrium position. The amount of displacement within the housing and the oscillation frequency at which the magnetic mass vibrates is controlled by characteristics of the generated magnetic fields, which are in turn controlled by control signals applied to the coils.

The control signals can be applied to the conductive coils using control circuitry. The control circuitry can include a controller and/or driver circuitry. For instance, a processor-based controller such as a microprocessor, field-programmable gate array, application specific integrated circuit, etc. can determine control signals that are to be provided to the controllers by drivers. The control signals may be generated and provided to the coils by one or more drivers that are electrically coupled to the coils. The controller can receive an indication of a target displacement and a target oscillation frequency for the magnetic mass. The target displacement and target oscillation frequency can be selected based on a desired haptic output. For example, the target displacement may be small and the target oscillation frequency may be high to provide a quick, high oscillation vibration in a wristband of a smart wearable user device. The controller receives the target displacement and target oscillation frequency and, in turn, determines control signals to send to the coils. Driver circuitry may then generate the determined control signals and issue the control signals to the respective coils in order to achieve the target displacement and target oscillation frequency. The generated magnetic fields of the system are controlled based on one or more characteristics of the control signal being provided to the coil, such as control signal voltage, control signal current, and/or control signal polarity. The controller determines the appropriate control signal characteristics for each coil to achieve the target displacement and target oscillation frequency. After the appropriate characteristics for each control signal are determined, the driver circuitry provides the control signals to each coil, which causes the coils to generate the magnetic fields and, in turn, displace and oscillate the magnetic mass within the housing to achieve the desired haptic response.

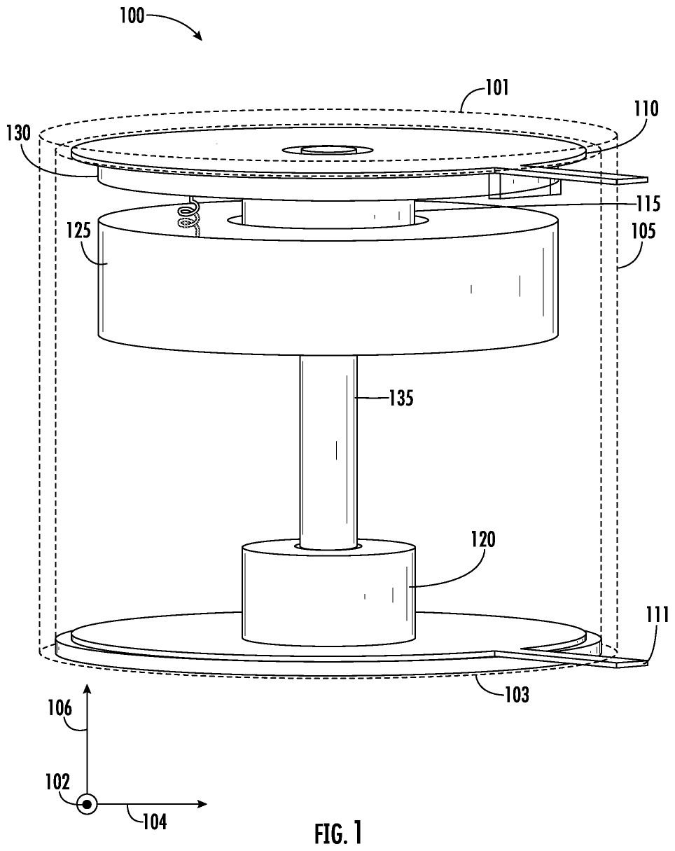

FIG. 1 illustrates a mass positioning system 100 in accordance with example embodiments of the present disclosure. In some embodiments, mass positioning system 100 may be a linear resonant actuator or another actuator that provides a haptic output or response.

Mass positioning system 100 includes a housing 105 that defines a set of orthogonal directions including vertical direction 106, longitudinal direction 102, and lateral direction 104. Housing 105 has a first end portion 101 and a second end portion 103 separated by spacing in the vertical direction 106. In some embodiments, housing 105 can have a cylindrical or cylindrical-like geometry having two bases (first end portion 101, second end portion 103), straight parallel sides, and a circular, oval, or elliptical cross section. In other embodiments, housing 105 can be a rectangular prism, cube, or other rectangular-like geometric figure having two bases (first end portion 101, second end portion 103) and four sides with a rectangular or cubical cross section. Although housing 105 in FIG. 1 is shown as an enclosed structure, any structure having first and second end portions may be used. The end portions need not be connected together. A housing may be much more general in nature. For example, two ends (a first end and a second end) may be provided and maintained at a substantially constant distance from one another in any manner. The structure(s) that hold the two ends at their relative position need not be a single structure, or even need to be connected at all.

A first circuit board 110 is positioned at the first end of housing 105 and a second circuit board 111 is positioned at the second end of housing 105. First circuit board 110 is electrically coupled to first conductive coil 115 and can include driver circuitry that provides a first control signal to first conductive coil 115, while second circuit board 111 is electrically coupled to a second conductive coil 120 and can include driver circuitry that provides a second control signal to second conductive coil 120. In some embodiments, first conductive coil 115 and second conductive coil 120 are coaxially aligned within housing 105.

In some embodiments, first conductive coil 115 and second conductive coil 120 can be cylindrical in shape, such as coils wrapped in a circular manner around a cylindrical body or wrapped in such a way as to form a cylindrical or cylindrical-like geometric shape with the coil. Other possible coil geometries can include square wrappings having a square cross section, such as coils wrapped around a rectangular prism or similar body, and elliptical wrappings having an elliptical cross section, such as coils wrapped around an elliptical cylinder or similar body. Each coil may extend in the vertical direction in some examples. In other examples, each coil may be substantially flat, including an increasing radius and occupying substantially the same vertical position within the housing. First conductive coil 115 and second conductive coil 120 can have a number of turns (number of wrappings) and a diameter of winding. Both the number of turns and the diameter of winding affect the magnetic field that is generated by first conductive coil 115 and second conductive coil 120. For example, magnetic flux density can increase in a coil with more turns, even if the coil covers the same distance as a different coil on a body.

When the first control signal and the second control signal pass through first conductive coil 115 and second conductive coil 120, respectively, each conductive coil generates a magnetic field based on the received control signal (e.g., first conductive coil 115 generates a first magnetic field based on the first control signal and second conductive coil 120 generates a second magnetic field based on the second control signal). Characteristics of the generated magnetic fields are defined by characteristics of the first control signal and the second control signal, such as voltages of the first control signal and second control signal, currents of the first control signal and second control signal, polarities of the first control signal and the second control signal, and the like.

Mass positioning system 100 includes a magnetic mass 125. Magnetic mass 125 may be made of a solid permanent magnetic material or a non-magnetic material in combination with a permanent magnetic material, such as non-magnetic material having a magnetic coating, a magnetic shell, a magnetic case, or one or more non-magnetic layers coupled with one or more magnetic layers and the like. Examples of non-magnetic materials include plastics, nonmagnetic metals such as copper or gold, rubber, and other materials. Examples of permanent magnetic materials may include neodymium and also materials such as ferrite or ferrite alloys, some combination of these materials, or other materials. In some embodiments, magnetic mass 125 can be shaped as a sphere or sphere-like shape. In other embodiments, magnetic mass 125 can be a cylinder or cylinder-like shape. In further embodiments, magnetic mass 125 can be a rectangular prism, a cube, or other rectangular-like shape.

Magnetic mass 125 rests at a neutral point within housing 105 when in an unexcited state (i.e. when the coils are de-energized). In some embodiments, the neutral point for magnetic mass 125 is a middle point of housing 105. In other embodiments, the neutral point for magnetic mass 125 may be proximate to the first end or proximate to the second end of housing 105. Mass positioning system 100 includes a mechanical spring 130 coupled to an upper surface of magnetic mass 125 and the first end portion 101 of housing 105. Mechanical spring 130 imparts a restoring force to magnetic mass 125 such that magnetic mass 125 rests at the neutral point when within housing 105 when in an unexcited state. Mechanical spring 130 allows magnetic mass 125 to oscillate about a displacement point within housing 105. Together, mechanical spring 130 and magnetic mass 125 form a spring-mass system. However, a person of ordinary skill in the art will appreciate that due to friction and other similar energy absorbing attributes, the system can be regarded as a spring-mass-damper system. A coil is depicted for mechanical spring 130 for illustrative purposes of the coupling between spring 130 and mass 125. It will be appreciated that a spring may take any form to impart a restorative force to mass 125 and thus may vary from the particular coil mechanism that is depicted. In some instances, a coiled spring may wrap around rod 135 for example.

It is noted that mechanical spring 130 can be coupled to a lower surface of magnetic mass 125 and the second end portion 103 of housing 105 in other embodiments. In some embodiments, mechanical spring 130 is a first mechanical spring coupled to the upper surface of magnetic mass 125 and the spring-mass-damper-system includes a second mechanical spring coupled to a lower surface of magnetic mass 125 and the second end portion 103 of housing 105.

In some example embodiments, magnetic mass 125 includes a center circular opening of a diameter larger than a diameter of first conductive coil 115 and second conductive coil 120, such that, as magnetic mass 125 is displaced within housing 105, the opening of magnetic mass 125 passes outside of first conductive coil 115 and second conductive coil 120 without substantially contacting magnetic mass 125.

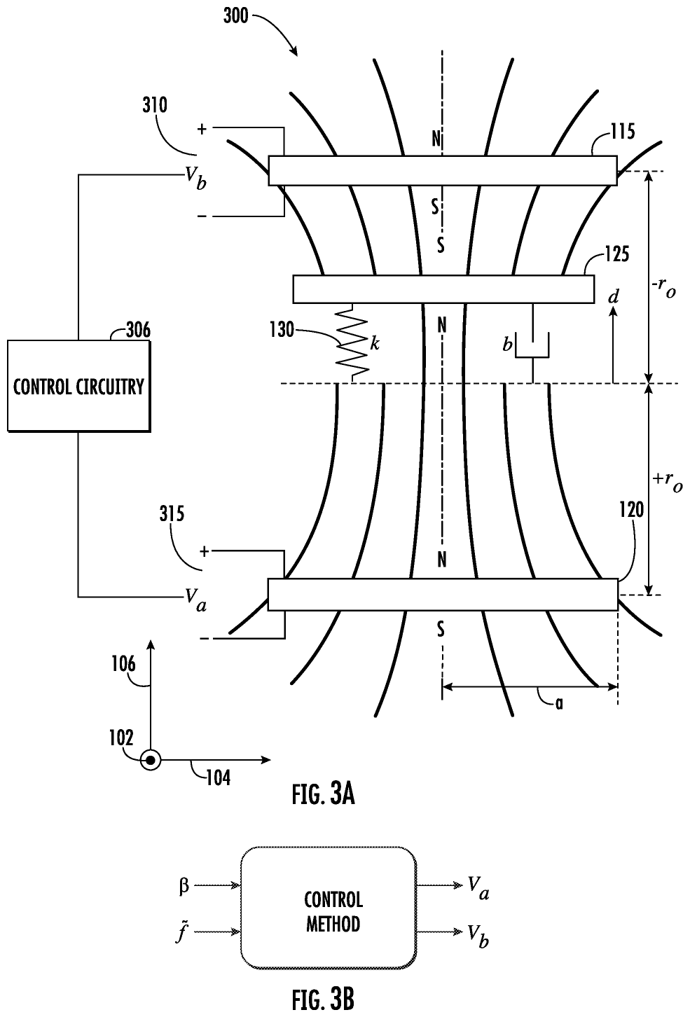

Magnetic mass 125 can be displaced within housing 105 and vibrate or oscillate around a point of displacement within housing 105 in response to first conductive coil 115 generating the first magnetic field and second conductive coil 120 generating the second magnetic field. Displacement is a positioning of the mass relative to the neutral or resting position. Displacement of magnetic mass 125 can be represented by variable “d” in at least FIG. 3 of this document and in equations presented in this document.

When magnetic mass 125 is displaced within housing 105, magnetic mass 125 is constrained to displace coaxially with first conductive coil 115 and second conductive coil 120. The distance magnetic mass 125 is displaced in housing 105 and the frequency at which magnetic mass 125 oscillates about the point of displacement is based on characteristics of the first magnetic field and the second magnetic field, such as magnetic field strength, magnetic field polarity, magnetic field gradient, and other characteristics.

Mass positioning system 100 may also include a rod 135 fixedly coupled to the first end and the second end of housing 105. The rod is decoupled from magnetic mass 125. When magnetic mass 125 displaces within housing 105, the rod passes through the central opening of magnetic mass 125 such that magnetic mass 125 is not constrained vertically by the rod. In some embodiments, first conductive coil 115 and second conductive coil 120 are wound around opposite end portions of the rod. Rod 135 provides mechanical support so that magnetic mass 125 is horizontally constrained so that it can be displaced vertically between the two end portions. Rod 135 may be formed of any material including dielectrics and conductive metals. A conductive material may concentrate magnetic fields from both of the coils along the metal rod. A larger force may be imparted on the mass by the coils by concentrating the magnetic fields along the rod.

Traditional mass displacement systems can allow for control of displacement of a magnetic mass using a single conductive coil, but cannot independently control both displacement and oscillation frequency of the magnetic mass.

In contrast, when control signals are passed through first conductive coil 115 and second conductive coil 120, magnetic mass 125 is displaced within housing 105 to a displacement point and oscillates about the displacement point at a controllable oscillation frequency. The control signals passed through first conductive coil 115 and second conductive coil 120 can be controlled such that the magnetic mass is able to reach a target displacement point, and exhibit a target oscillation frequency when perturbed about the displacement point. In particular, the addition of the second generated magnetic field from second conductive coil 120 allows for control of the gradient of the total magnetic field being generated by first conductive coil 115 and second conductive coil 120. By controlling the gradient of the total magnetic field, a target oscillation frequency of magnetic mass 125 can be achieved without having to modify a target displacement position of magnetic mass 125.

By controlling both target displacement amount and target oscillation frequency, mass positioning system 100 allows for greater control of haptic response, such as allowing for more unique combinations of haptic responses (e.g., target displacement position and target oscillation frequency pairs) and more controllable types of haptic responses. For example, mass positioning system 100 can achieve a target displacement position at a higher oscillation frequency than can be reached in a single coil system due to the inability of the single coil system to independently control target displacement position and target oscillation frequency.

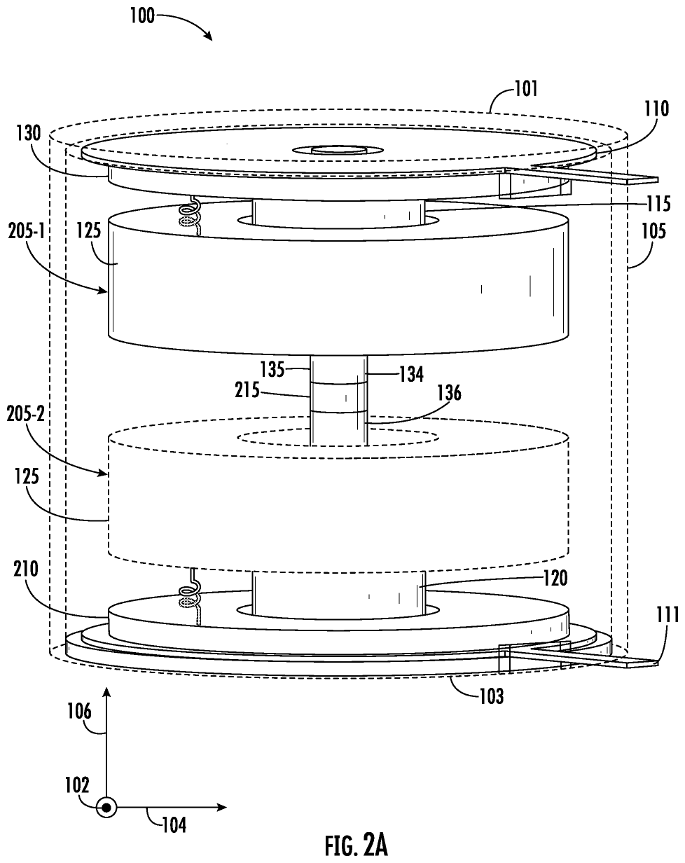

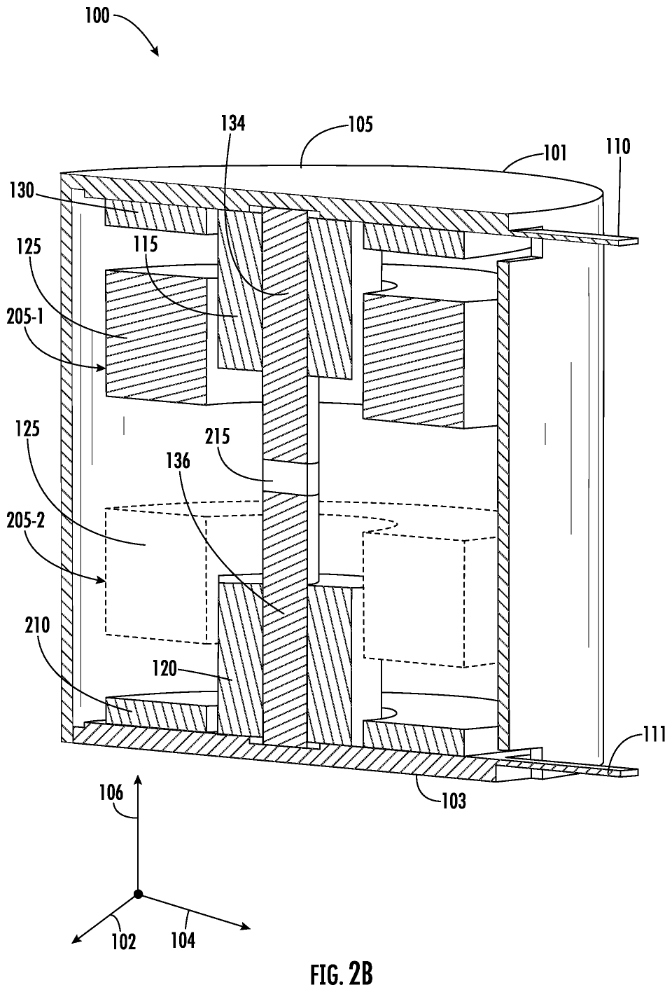

FIG. 2A illustrates a mass positioning system 100 in accordance with another example embodiment of the present disclosure. FIG. 2B is an isometric cross-sectional view of mass positioning system 100. In this embodiment, mass positioning system 100 includes a second mechanical spring 210 that couples the magnetic mass 125 to a second end portion of the system. FIGS. 2A and 2B depict magnetic mass 125 at a first displacement 205-1 and a second displacement 205-2. The system 100 further includes a dielectric portion 215 separating a first conductive portion 134 and a second conductive portion 136 of the rod 135. For example, the dielectric could be air or a solid dielectric positioned between the conductive portions. A dielectric separating the conductive portions of the rod can reduce coupling between the coils. For instance, operation of one coil may induce a voltage in the other coil. While this effect can be controlled using control circuitry to determine the appropriate levels of the voltages applied to each coil, a dielectric can reduce the amount of flux coupling to enhance the independent controllability of each coil. In some examples, the dielectric may be positioned in the middle of the rod. In other examples, the dielectric can be positioned closer to one end. In such an example, the mass can operate in a region closer to the opposite end so that the flux line divergence is positioned away from the mass.

FIG. 3 is a partial circuit diagram 300 showing electrical and control components of mass positioning system 100. Mass positioning system 100 includes control circuitry 306. Control circuitry 306 can include one or more controllers for determining control signals such as voltages and/or currents to apply to the coils. Control circuitry 306 can additionally or alternatively include driver circuitry to generate and apply determined control signals to the coils. Any suitable processing device (e.g., a processor core, a microprocessor, an ASIC, a FPGA, a microcontroller, etc.) can be used to implement the controller. The controller can receive requests from external computing systems, such as from a user device, to generate a haptic response using mass positioning system 100. For example, the controller may receive a request from control software in a smart wearable to generate a haptic response in response to a condition being met, such as the smart wearable receiving a notification from a software application or a user of the smart wearable performing physical activity. In another example, the controller may receive a request from control software in an automobile to generate a haptic response for a steering column or steering wheel of the vehicle in response to a condition being met, such as detection of a second vehicle in a blind spot of the vehicle or detection of a user being distracted.

In some embodiments, the request from the external computing systems includes parameters for the desired haptic response. For example, control software in a smart wearable may request a single short, high frequency haptic response for receiving a notification from a software application but may request a series of longer, lower frequency haptic responses when a user of the smart wearable is receiving a call or a medical emergency, such as an abnormal heart rate, is detected in the user.

Based on the received request, the controller determines a first control signal 310 for first conductive coil 115 and a second control signal 315 for second conductive coil 120 to be provided to the coils. Control circuitry 306 can include driver circuitry such as one or more drivers (not shown) in communication with the controller to generate and provide the determined control signals 310 and 315 to respective coils 115 and 120. In some embodiments, first control signal 310 and second control signal 315 may include control voltages applied to first conductive coil 115 and second conductive coil 120, respectively. In other embodiments, first control signal 310 and second control signal 315 may include control currents applied to first conductive coil 115 and second conductive coil 120, respectively. The driver circuitry receives the determination from the controller 306 and generates the control signals, which may include signal attributes such as voltage, current, phase, duty cycle, and the like, for both first control signal 310 and second control signal 315.

In some embodiments, first control signal 310 and second control signal 315 are first and second control voltages. The controller receives a target displacement of magnetic mass 125 and a target oscillation frequency of magnetic mass 125 and determines the first and second control voltages to be applied to the first conductive coil 115 and second conductive coil 120, respectively, to achieve the target displacement and target oscillation frequency.

When the first and second control voltages are applied to the first conductive coil 115 and second conductive coil 120, magnetic fields and, therefore, magnetic forces are generated. The magnetic forces imparted to the magnetic mass 125 by each of first conductive coil 115 and second conductive coil 120 depend, in part, on the geometry of the coil. For coils in the form of a ring (as opposed to cylindrical, or pancake shape) these forces may be expressed as defined in Equations 1 and 2.

$${F}_{a} = \frac{{V}_{a} {Ca}^{2} ( {r}_{o} + d )}{{( {a}^{2} + {( {r}_{o} + d )}^{2} )}^{5 / 2}} = \frac{{V}_{a} C ( ρ + δ )}{{{a}^{2} ( 1 + {( ρ + δ )}^{2} )}^{5 / 2}} \qquad Equation 1$$

$${F}_{b} = \frac{{V}_{b} {Ca}^{2} ( - {r}_{o} + d )}{{( {a}^{2} + {( - {r}_{o} + d )}^{2} )}^{5 / 2}} = \frac{{V}_{b} C ( - ρ + δ )}{{{a}^{2} ( 1 + {( - ρ + δ )}^{2} )}^{5 / 2}} \qquad Equation 2$$

In Equation 1, Fₐ is the magnetic force imparted to the magnetic mass 125 when the first control voltage Vₐ is applied to first conductive coil 115 and F_{b} is the magnetic force imparted to the magnetic mass 125 when the second control voltage V_{b} is applied to second conductive coil 120. rₒ is an offset of the centroid of second conductive coil 120 from a position of magnetic mass 125 when first mechanical spring 130 is in an unstretched state. d is the displacement of magnetic mass 125 from the at-rest position, a is a radius of each of first conductive coil 115 and second conductive coil 120. Many of the properties of the mass-coil system that influence the magnitude of the imparted force can be distilled down to a single constant, C defined in Equation 3:

$$C = \frac{- 3 τμ N}{2 R} \qquad Equation 3$$

where p is the permeability of the medium in which the magnetic field exists, Nis the number of turns in coils 115 and 120, R is the resistance of the coils 115 and 120, and τ represents the magnitude of the dipole moment of the magnetic mass.

The parameters δ and ρ are dimensionless. They relate to d and rₒ such that the following equalities hold:

$$d = δ a \qquad Equation 4$$

$${r}_{o} = ρ a \qquad Equation 5$$

In this way, δ is the ratio of spring elongation to coil radius. Similarly, ρ is the ratio of mass offset to coil radius. However, the non-dimensional parameter δ may be alternatively expressed in terms of the non-dimensional parameter ρ, and a scalar, β, such that Equation 6 holds:

$$δ = βρ \qquad Equation 6$$

According to Equation 6, when β is equal to 1, then δ is equal to ρ. This corresponds to the configuration where the mass has been displaced such that it is coincident with the upper coil. Similarly, when β is equal to −1, then δ is equal to −ρ. This corresponds to the configuration where the mass has been displaced such that it is coincident with the lower coil. In this way, β, represents desired displacement—albeit normalized.

According to example aspects of the disclosure, the design of the mass positioning system enables the magnetic mass 125 of the mass positioning system 100 to exhibit any oscillation frequency at any displacement, d, within the housing 105. To realize this benefit, a suitable control method can be used. Disclosed here is one such embodiment of a suitable control method.

To assist in developing this control method, consider a force, Fₕ, which one desires to impart to the magnetic mass 125 by virtue of the electromagnetic field. During periods of steady-state or slow dynamic motion, this desired force would be resisted entirely by the spring. Therefore, the following equality may be established.

$${F}_{h} = k d \qquad Equation 7$$

Now consider a second force, Fₘ, that represents the force required to displace the mass maximally upward a distance rₒ. This is represented in equation form as:

$${F}_{m} = {kr}_{o} \qquad Equation 8$$

Finally, suppose that the desired force, Fₕ, is normalized by Fₘ. Here, this is given the symbol F_{β} and defined as:

$${F}_{β} ≡ \frac{{F}_{h}}{{F}_{m}} \qquad Equation 9$$

The dimensionless parameter, F_{β}, is referred to herein simply as the pseudo force. Though technically not a force, F_{β} does provide an indication of the magnitude and direction of the desired force with respect to the force required to cause maximal displacement.

The utility of the pseudo force becomes more apparent when Equation 9 is considered in light of Equations 4, 5, and 6. From these one may observe that the following equalities hold:

$${F}_{β} = \frac{{F}_{h}}{{F}_{m}} = \frac{kd}{{kr}_{o}} = \frac{d}{{r}_{o}} = \frac{δ a}{ρ a} = β \qquad Equation 10$$

Thus, the parameter, β, may be dually regarded: one the one hand, as described with respect to Equation 6, β represents desired displacement; on the other hand, and contemporaneously, β represents the force needed to cause said displacement.

Given this understanding, we now illustrate the inputs and outputs of the control scheme, as depicted in FIG. 3B.

FIG. 3B illustrates that one of the inputs to the control method β, representing either normalized displacement or normalized force to which the magnetic mass 125 is to be subjected. A second input is \tilde{f}, which represents the desired frequency of the system 100 once the magnetic mass 125 is perturbed from equilibrium. Given these inputs, the control method determines the voltages Vₐ 315 and V_{b} 310, with which the respective coils should be energized to realize:
1) The desired frequency response, \tilde{f}, and
2) The desired displacement, d, corresponding to the given pseudo force, β.

Since β and \tilde{f}, can be defined arbitrarily as a function of time, the control method enables a user to actuate the mass positioning system 100 such that it exhibits any frequency, at any position, at any time (within the physical limitations of the device).

The control method consists of solving—for every instance of time for which \tilde{f} and β are specified—mathematical relationships relating displacement and field gradient to control effort. These relationships are disclosed in Equation 11:

$$[ \begin{matrix}\frac{( β + 1 )}{{( 1 + {{ρ}^{2} ( β + 1 )}^{2} )}^{5 / 2}} & \frac{( β - 1 )}{{( 1 + {{ρ}^{2} ( β - 1 )}^{2} )}^{5 / 2}} \\ \frac{( 1 - 4 {{ρ}^{2} ( β + 1 )}^{2} )}{{( 1 + {{ρ}^{2} ( β + 1 )}^{2} )}^{7 / 2}} & \frac{( 1 - 4 {{ρ}^{2} ( β - 1 )}^{2} )}{{( 1 + {{ρ}^{2} ( β - 1 )}^{2} )}^{7 / 2}}\end{matrix} ] [ \begin{matrix}{V}_{a} \\ {V}_{b}\end{matrix} ] = [ \begin{matrix}\frac{{ka}^{2} β}{C} \\ \frac{{a}^{3} G}{C}\end{matrix} ] \qquad Equation 11$$

The parameters ρ, k, a, and C all represent invariant physical characteristics of the mass positioning system 100, and are accordingly, represented by constant scalar values. The parameter G, representing the necessary field gradient is determined from:

$$G = k - \frac{4 m {π}^{2} {\tilde{f}}^{2}}{1 - {ζ}^{2}} \qquad Equation 12$$

where ξ is the damping ratio representing damping effects inherent to the mass positioning system 100 and k is the spring constant of mechanical spring 130. The symbol m, represents the equivalent mass of the mass positioning system. It is related to the mass of the magnetic mass 125, and the mass of the housing 105 such that:

$$m = \frac{{m}_{housing} {m}_{magnetic mass}}{{m}_{housing} + {m}_{magnetic mass}} \qquad Equation 13$$

Equation (11) is a linear system of equations with unknowns Vₐ and V_{b}. Accordingly, given β and G, (11) is easily solved for Vₐ and V_{b} using linear algebra or other techniques well-know to a personal of ordinary skill in the art.

Therefore, the system of equations defined in Equation (11) and (12) only needs input values of required pseudo force β for target displacement and target oscillation frequency \tilde{f} to solve for required voltages Vₐ and V_{b}, which are then applied to first conducting coil 115 and second conducting coil 120 to achieve the target displacement and target oscillation frequency.

In light of the preceding, a method of controlling the mass positioning system 100 may consist of the following steps:
1. Specify a desired value for β. This value may be interpreted as either the pseudo force imparted to the magnetic mass 125, or the normalized displacement corresponding to the pseudo force.
2. Specify a desired value for \tilde{f}. This value represents the oscillation frequency (in Hertz) with which the mass positioning system 100 will respond to the pseudo force.
3. Calculate G from Equation (12) and the specified value of \tilde{f}.
4. Solve Equation (11) for control voltages Vₐ and V_{b}.
5. Energize lower coil 120 and upper coil 115 with voltages Vₐ 315 and V_{b} 310, respectively.
6. Repeat the preceding at each time-step for which control of the mass positioning system 100 is desired.

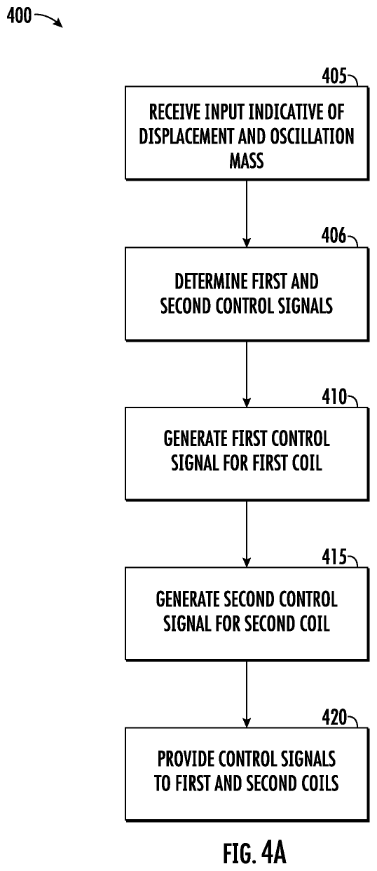

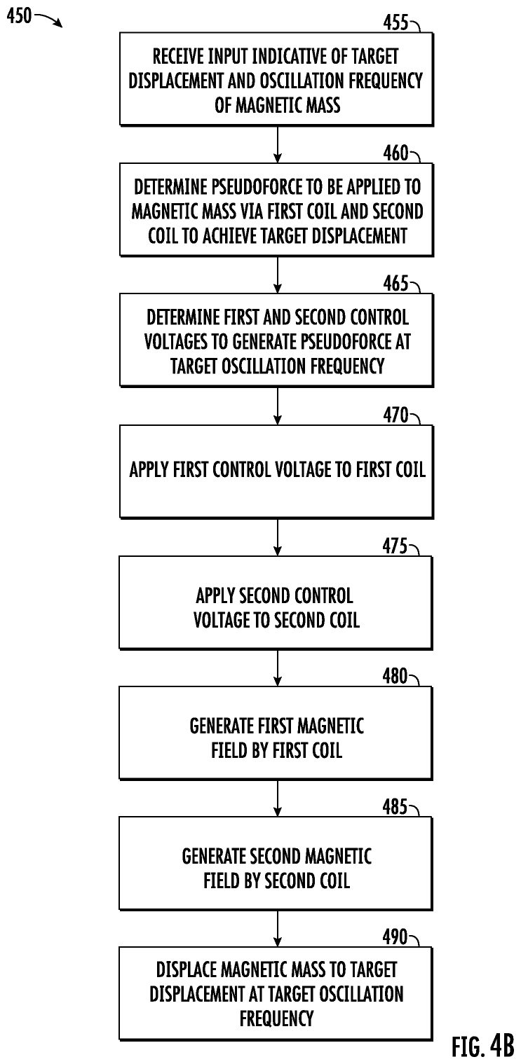

FIG. 4A illustrates a flow chart showing a method 400 for generating control signals 310 and 315 for controlling mass positioning system 100 in accordance with an example embodiment of the present disclosure. In some embodiments, method 400 can be performed by control circuitry 306 in response to receiving a request to generate a haptic response for an electronic device. Although method 400 is discussed with regards to control circuitry 306, it is to be understood that other control technology or computing systems can perform method 400.

At block 405, control circuitry 306 such as a controller receives an input indicative of a target displacement and a target oscillation frequency for magnetic mass 125. The controller can receive the input from an outside computing system, such as a haptic response request system or other software application. For example, the controller can receive an input from a haptic response request system in response to the haptic response request system detecting a need to provide haptic feedback to an electronic device, such as vibrating a smartphone, vibrating a steering wheel, vibrating a smart wearable, and the like.

The input defines the target displacement and target oscillation frequency for the desired haptic response. For example, if a user is receiving a phone call on the electronic device, the desired target displacement and target oscillation frequency may be one in a series of “bursts,” or short displacement, high oscillation frequency haptic responses. In another example, if the user of the electronic device is being notified of a push notification from a software application, the input may define a larger target displacement and a lower target oscillation frequency.

At block 406, the control circuitry 306 (e.g., a controller) determines a first control signal for the first conductive coil and a second control signal for the second conductive coil based on the target displacement and target oscillation frequency received at block 405.

At block 410, the control circuitry 306 (e.g., driver circuitry) generates the first control signal 310 for first conducting coil 115 based on the determined first control signal 310. First control signal 310 can be a control voltage, a control current, and the like. Additional details regarding generating first control signal 310 can be found below in relation to FIG. 4B.

At block 415, control circuitry 306 (e.g., driver circuitry) generates the second control signal 315 for second conducting coil 120 based on the determined second control signal 315. Second control signal 315 can be a control voltage, a control current, and the like. Additional details regarding generating second control signal 315 can be found below in relation to FIG. 4B.

At block 420, the generated control signals 310 and 315 are provided to the first and second coils, respectively.

FIG. 4B illustrates a flow chart showing a method 450 for generating magnetic fields using first conduction coil 115 and second conduction coil 120 to control magnetic mass 125 in mass positioning system 100 in accordance with an example embodiment of the present disclosure. Although method 450 is discussed with regards to control circuitry 306, it is to be understood that other control technology or computing systems can perform method 450.

At block 455, control circuitry 306 receives an input indicative of a target displacement and a target oscillation frequency for magnetic mass 125. A controller of the control circuitry 306 can receive the input from an outside computing system, such as a haptic response request system or other software application. For example, the controller can receive an input from a haptic response request system in response to the haptic response request system detecting a need to provide haptic feedback to an electronic device, such as vibrating a smartphone, vibrating a steering wheel, vibrating a smart wearable, and the like.

The input defines the target displacement and target oscillation frequency for the desired haptic response. For example, if a user is receiving a phone call on the electronic device, the desired target displacement and target oscillation frequency may be one in a series of “bursts,” or short displacement, high oscillation frequency haptic responses. In another example, if the user of the electronic device is being notified of a push notification from a software application, the input may define a larger target displacement and a lower target oscillation frequency.

At block 460, the control circuitry 306 determines a pseudo force to be applied to magnetic mass 125 via magnetic fields generated by first conductive coil 115 and second conductive coil 120 in order to achieve the target displacement. In some embodiments, the pseudo force is defined by the received input. For example, the input may define a pseudo force of 0.75 (i.e. 75%), which is the theoretical force needed to displace magnetic mass 125 to a point 75% towards maximum displacement. In other embodiments, the input may define a target displacement (e.g., 0.1 millimeters) and the controller can calculate the required pseudo force needed to displace magnetic mass 125 to the target displacement.

At block 465, the control circuitry 306 determines a first control voltage to generate for first conductive coil 115 and a second control voltage to generate for second conductive coil 120 such that the required pseudo force is generated in mass positioning system 100. To generate the pseudo force in mass positioning system 100, driver circuitry can generate and apply voltages to first conductive coil 115 and second conductive coil 120. When electric currents pass through the coils, magnetic fields are produced. Characteristics of the produced magnetic fields depend upon the voltage applied to each of first conductive coil 115 and second conductive coil 120. The gradient of the produced magnetic field can be controlled based on the amount of voltage applied to second conductive coil 120 and the amount of voltage applied to first conductive coil 115.

In some embodiments, control circuitry 306 determines the first control voltage and second control voltage using Equation (11), Equation (12), and Equation (13). The inputs to this system of equations are the target displacement (or corresponding pseudo force) and target oscillation frequency.

At block 470, control circuitry 306 generates the first control voltage and provides the first control voltage to first conductive coil 115. At block 475, control circuitry 306 generates the second control voltage and provides the second control voltage to second conductive coil 120. Control circuitry 306 may include one or more drivers that generate and apply the control voltages. It is to be understood that blocks 470 and 475 can be performed in any order and/or can be performed simultaneously or near-simultaneously.

At block 480, first conductive coil 115, due to the application of the first control voltage, generates a first magnetic field. At block 485, second conductive coil 120, due to the application of the second control voltage, generates a second magnetic field. It is to be understood that blocks 480 and 485 can be performed in any order and/or can be performed simultaneously or near-simultaneously.

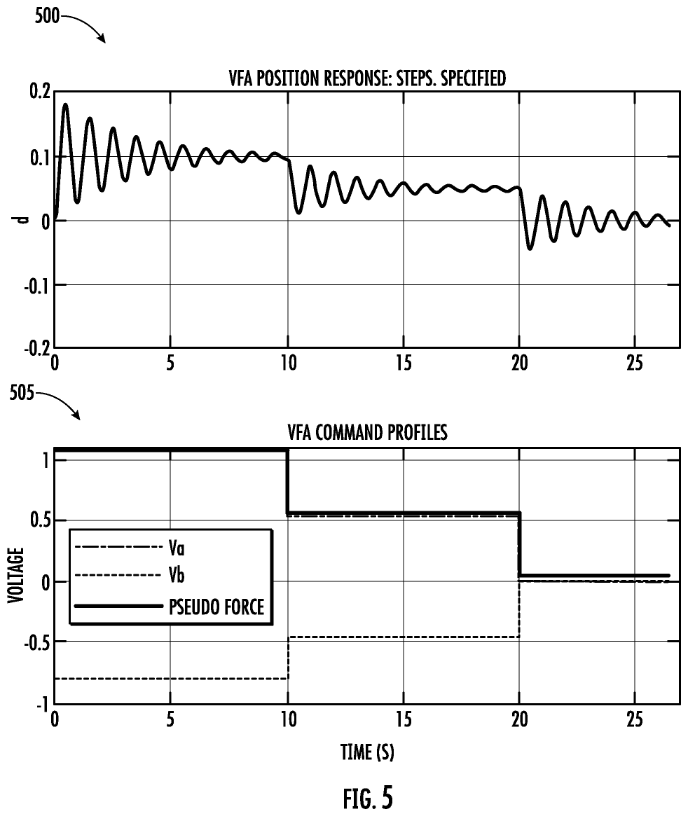

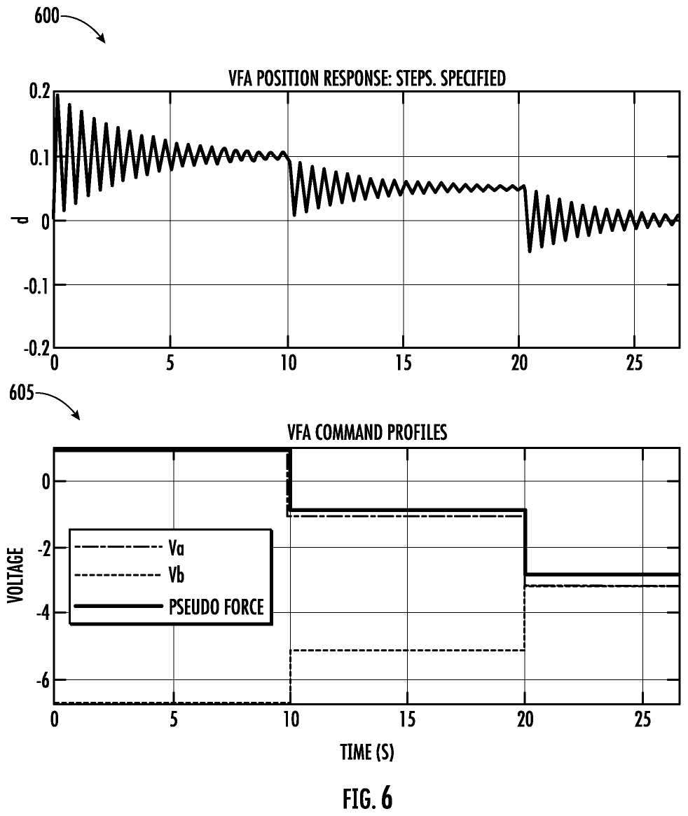

At block 490, in response to the generation of the first magnetic field and the second magnetic field, magnetic mass 125 displaces within housing 105. Magnetic mass 125 displaces to a particular displacement position. When perturbed about the displacement position, the magnetic mass 125 oscillates at the target oscillation frequency based on the generated magnetic fields. Additional details can be found below in relation to FIGS. 5 and 6.

FIG. 5 is a set of graphs, including first graph 500 and second graph 505, illustrating control of an example mass positioning system 100 with specific physical properties (i.e. spring constant, k, system constant, C, damping ratio, ζ, and coil radius a) in accordance with an example embodiment of the present disclosure. First graph 500 illustrates displacement and oscillation of magnetic mass 125. Second graph 505 illustrates first control signal 310 (control voltage Vₐ) and second control signal 315 (control voltage V_{b}) associated with different displacement and oscillation values. For example, when Vₐ is 1.1 volts and V_{b} is −0.75 volts, the resulting displacement of magnetic mass 125 is 0.1 millimeters and magnetic mass oscillates about the 0.1 millimeter displacement point at a first oscillation frequency. When Vₐ is stepped down to 0.5 volts and V_{b} is stepped up to −0.5 volts, magnetic mass 125 displaces to 0.05 millimeters, but still oscillates about the 0.05 millimeter displacement point at the first oscillation frequency. Similarly, when both Vₐ and V_{b} equal zero volts, magnetic mass 125 returns to a rest point. If magnetic mass 125 returns to the rest point (e.g., magnetic mass 125 returns from being displaced by application of Vₐ and V_{b} after Vₐ and V_{b} return to zero), magnetic mass 125 may oscillate about the rest point until mechanical spring 130 can fully dampen the oscillation.

FIG. 6 is a set of graphs, including third graph 600 and fourth graph 605, illustrating control of the same mass positioning system 100 considered with respect to FIG. 5. Third graph 600 illustrates displacement and oscillation of magnetic mass 125. Fourth graph 605 illustrates first control signal 310 (control voltage Vₐ) and second control signal 315 (control voltage V_{b}) associated with different displacement and oscillation values. For example, when Vₐ is 1 volt and V_{b} is −6.5 volts, the resulting displacement of magnetic mass 125 is 0.1 millimeters and magnetic mass oscillates about the 0.1 millimeter displacement point at a second oscillation frequency, which can be a greater oscillation frequency than the first oscillation frequency described in FIG. 5. When Vₐ is stepped down to −1 volt and V_{b} is stepped up to −5 volts, magnetic mass 125 displaces to 0.05 millimeters, but still oscillates about the 0.05 millimeter displacement point at the second oscillation frequency. Similarly, when Vₐ is stepped down again to −3 volts and V_{b} is stepped up again to −3 volts, magnetic mass 125 returns to a rest point because Vₐ and V_{b} are now equal. If magnetic mass 125 is returning to the rest point (e.g., magnetic mass 125 is returning from being displaced by application of Vₐ and V_{b} after Vₐ and V_{b} become equal), magnetic mass 125 may oscillate about the rest point until mechanical spring 130 can fully dampen the oscillation.

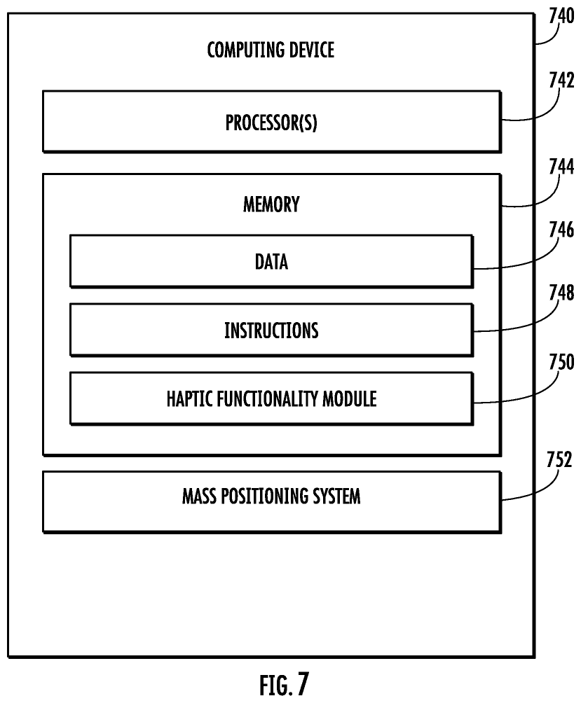

FIG. 7 depicts a block diagram of an example computing device 705 that includes mass positioning system 100.

User computing device 740 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

User computing device 740 includes one or more processors 742 and a memory 744. One or more processors 742 can be any suitable processing device (e.g., a processor core, a microprocessor, an ASIC, a FPGA, a controller, a microcontroller, etc.) and can be one processor or a plurality of processors that are operatively connected. Memory 744 can include one or more non-transitory computer-readable storage mediums, such as RAM, ROM, EEPROM, EPROM, flash memory devices, magnetic disks, etc., and combinations thereof. Memory 744 can store data 746 and instructions 748 which are executed by processor 742 to cause user computing device 740 to perform operations. Electronic items and/or data describing electronic items can be stored in one more local memory locations of user computing device 740. For example, the local memory location can correspond with memory 744.

User computing device 740 also includes haptic functionality module 750. Haptic functionality module 750 can include data and instructions related to determining when a haptic response is needed, what type of haptic response is needed, and generating control signals for providing the haptic response using one or more mass positioning systems.

User computing device 740 can include one or more mass positioning systems 752. Example types of mass positioning systems 752 include linear resonant actuators (LRA), eccentric rotating mass (ERM) actuators, and other actuators that provide a haptic output or response.

User computing device 740 may communicate with other computing devices through wired or wireless means, such as a wired or wireless network. The network can be any type of communications network, such as a local area network (e.g., intranet), wide area network (e.g., Internet), or some combination thereof and can include any number of wired or wireless links. In general, communication over the network can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A mass positioning system, comprising:
a first end portion separated from a second end portion;
a mechanical spring coupled to the first end portion;
control circuitry configured to generate a first control signal and a second control signal;
a first conductive coil proximate to the first end portion and configured to generate a first magnetic field in response to the first control signal;
a second conductive coil proximate to the second end portion and configured to generate a second magnetic field in response to the second control signal; and
a magnetic mass coupled to the mechanical spring and having a displacement that is responsive to the first magnetic field and the second magnetic field, the mass positioning system having an oscillation frequency that is controllable by the first control signal or the second control signal.

2. The mass positioning system of claim 1, wherein the oscillation frequency is controllable in response to changes in the first magnetic field or the second magnetic field, and wherein changes in the first magnetic field or the second magnetic field are based on the first control signal or the second control signal, respectively.

3. The mass positioning system of claim 1, wherein the displacement of the magnetic mass is controllable in response to changes in the first magnetic field or the second magnetic field, and wherein changes in the first magnetic field or the second magnetic field are based on the first control signal or the second control signal, respectively.

4. The mass positioning system of claim 1, wherein the magnetic mass has a first predetermined oscillation frequency at a first predetermined displacement in response to a first combination of the first control signal and the second control signal and a second predetermined oscillation frequency at a second predetermined displacement in response to a second combination of the first control signal and the second control signal.

5. The mass positioning system of claim 1, wherein:
the control circuitry includes one or more drivers configured to generate the first control signal and the second control signal to control the displacement of the mass positioning system.

6. The mass positioning system of claim 1, wherein:
the control circuitry includes a controller configured to determine the first control signal for the first conductive coil and the second control signal for the second conductive coil based at least in part on a target displacement for the magnetic mass and a target oscillation frequency for the system.

7. The mass positioning system of claim 1, further comprising:
a rod fixedly coupled to the first end portion and the second end portion and decoupled from the magnetic mass, the rod passing through an opening in the magnetic mass.

8. The mass positioning system of claim 7, wherein the rod includes two conductive portions separated by a dielectric.

9. The mass positioning system of claim 8, wherein the dielectric is an open space separating the two conductive portions of the rod.

10. The mass positioning system of claim 7, wherein the first conductive coil is wrapped around a first conductive portion of the rod and the second conductive coil is wrapped around a second conductive portion of the rod.

11. The mass positioning system of claim 1, wherein the mechanical spring is a first mechanical spring, the mass positioning system further comprising:
a second mechanical spring coupled to the magnetic mass and the second end portion.

12. The mass positioning system of claim 1, wherein the magnetic mass comprises:
a non-magnetic component; and
a magnetic component.

13. (canceled)

14. (canceled)

15. A linear resonant actuator, comprising:
a first end portion and a second end portion;
a mechanical spring coupled to the first end portion;
a first conductive coil proximate to the first end portion and configured to generate a first magnetic field in response to a first control signal;
a second conductive coil proximate to the second end portion and configured to generate a second magnetic field in response to a second control signal; and
a magnetic mass coupled to the mechanical spring and having a displacement that is responsive to the first magnetic field and the second magnetic field.

16. The linear resonant actuator of claim 15, further comprising:
a rod fixedly coupled to the first end portion and the second end portion and decoupled from the magnetic mass, the rod passing through an opening in the magnetic mass.

17. A method, comprising:
applying a first control signal to a first conductive coil proximate a first end portion of a mass positioning system;
applying a second control signal to a second conductive coil proximate to a second end portion of the mass positioning system;
generating a first magnetic field by the first conductive coil in response to the first control signal;
generating a second magnetic field by the second conductive coil in response to the second control signal; and
displacing a magnetic mass to a target displacement at a target oscillation frequency affected by the first control signal and the second control signal.

18. The method of claim 17, wherein the first control signal is an operating voltage for the first conductive coil and the second control signal is an operating voltage for the second conductive coil.

19. The method of claim 17, wherein the mass positioning system has a first predetermined oscillation frequency at a first predetermined magnetic mass displacement in response to a first combination of the first control signal and the second control signal and a second predetermined oscillation frequency at a second predetermined displacement in response to a second combination of the first control signal and the second control signal.

20. The method of claim 17, wherein the first control signal is indicative of an operating voltage for the first conductive coil and the second control signal is indicative of an operating voltage for the second conductive coil.

21. The method of claim 17, the method further comprising:
determining the first control signal for the first conductive coil and the second control signal for the second conductive coil of the mass positioning system, wherein the determination of the first control signal and second control signal is based on a target displacement of the magnetic mass and a target oscillation frequency of the mass positioning system, wherein the first conductive coil is proximate to a first end portion of the mass positioning system and configured to generate a first magnetic field in response to the first control signal and the second conductive coil is proximate to a second end portion and configured to generate a second magnetic field in response to the second control signal; and
providing the first control signal to the first conductive coil and the second control signal to the second conductive coil.

22. The method of claim 17, when the oscillation frequency is controllable in response to changes in the first magnetic field or the second magnetic field, and wherein changes in the first magnetic field or the second magnetic field are based on the first control signal or the second control signal, respectively.
